(19) United States
(12) Patent Application Publication
(10) Pub. No.: US 2001/0050789 A1
(43) Pub. Date: Dec. 13, 2001

(54) Method for controlling signal path in optical transmission system

(75) Inventor: Seung Wook Jung, Kunpo (KR)

Correspondence Address: FLESHNER & KIM, P.O. Box 221200, Chantilly, VA, 20153-1200, US

(73) Assignee: LG Electronics Inc.

(21) Appl. No.: 09/749,417

(22) Filed: Dec. 28, 2000

(30) Foreign Application Priority Data
Dec. 29, 1999 (KR) 64624/1999

(51) Int. Cl. H04B 10/20; H04J 14/00; H04B 10/08

(52) U.S. Cl. 359/110; 359/119

(57) ABSTRACT

A signal path control method is provided to carry out a signal path provision and auto protection in an optical transmission system. In the signal path control method in an optical transmission system according to the present invention, the path is provided and controlled by dividing the same into a subscriber service path for providing voice-oriented services as in the conventional art and a new subscriber service path for providing new high-speed/very high-speed data services, said new subscriber service path including a through path, add-drop path, ring add-drop path, east-west add-drop & through path, and east-west add-drop & through path.

### BACKGROUND OF THE INVENTION

1. Field of the Invention

The present invention relates to an optical transmission system, and more particularly, to a method for controlling a signal path in an optical transmission system.

2. Description of the Background Art

FIG. 1 is a block diagram of a general optical transmission system.

As illustrated in FIG. 1, a conventional optical transmission system (hereinafter, “system”) includes; an optical signal transmitting/receiving unit 10 for converting an optical signal into an electric signal; a path signal control unit for carrying out path control and auto path protection operation by demultiplexing an output signal of the optical signal transmitting/receiving unit 10; a subscriber service processing unit 30 for processing voice and data of a local subscriber inputted through a path set by the path signal control unit 20; an optical signal transmitting/receiving unit 40 for converting an electric signal of a remote subscriber outputted from the path signal control unit 20 into an optical signal to thus transmit the same; and a system control unit 40 for controlling the overall operation of the system.

The operation mode of the system is divided into a terminal operation mode, add-drop operation mode, and ring operation mode. The configuration of the transmission network is divided into a point-to-point network, linear add-drop multiplex network, and undirectional protection self-healing ring network. At this time, the system operation mode, network configuration, and path control function conform to the Bellcore (Bell Communication Research Inc.,) specification in North America and the ITU-T(International Telecommunications Union Telecommunication) specification.

FIG. 2 is a view illustrating an example of a connection in the linear add-drop multiplex network among the configurations of the transmission network. As illustrated in FIG. 2, in the linear add-drop multiplex network, an optical signal is formed in such a manner that it is added in system 1 and is dropped in system 2.

The “path control function” carried out by the path signal control unit 20 is differently operated according to the system operation mode and the network configuration, and it is divided into two main functions, i.e., a “path provision function” and “auto path protection function”.

The “path provision function” is a function for configuring an appropriate path according to the system operation mode and network configuration, which is slightly differentiated according to the system operation mode, as illustrated in FIGS. 3A and 3B. The terminal operation mode and the ADM operation mode provides a through path and an add-drop path, respectively, and the ring operation mode provides a through path and a ring add-drop path.

Therefore, when the direction of a transmitted/received optical signal is divided into “east” and the “west”, as illustrated in FIG. 3A, the through path is a path for transmitting a signal received from the east to the west and vice versa in all system operation modes without conversion of a path signal. In particular, in the case that a signal demultiplexed from the optical signal is not processed in a local system, the through path is a path for directly transmitting the demultiplexed signal to the next system (not shown) through the optical signal transmission/receiving unit 40.

The add-drop path serves to connect the optical signal received from the east or west to the subscriber service processing uni30. Th path for connecting the optical signal to the subscriber service processing unit 30 is referred to as “drop”, and the path for connecting the signal inputted from the subscriber service processing unit 30 is referred to as “add”.

In addition, as illustrated in FIG. 3B, in the ring operation mode, the ring add-drop path is configured such that the optical signal received from the east or west is demultiplexed into a signal path to thus drop the same to the subscriber service processing unit 30 and the signal inputted from the subscriber service processing unit 30 is added to be multiplexed to the optical signal of both directions (east and west).

Hence, the add-drop path and the ring add-drop path are used in the case that the path signal demultiplexed from the optical signal is used for use in subscriber services. In particular, in the ring operation mode, a remote system has a drop path for connecting a subscriber service signal in both directions in order to receive a signal of the direction in which there is no fail.

The “path protection function” is a function which is adapted only in the case that the system operation mode is the ring operation mode, and the transmission network configuration is the undirectional protection self-healing ring network. In other words, in the system operation mode of the terminal operation mode or ADM operation mode, the optical signal transmission/receiving unit 10 for receiving an optical signal is duplexed. Thus, when a hardware or signal fail occurs, the optical signal transmission/receiving unit 10 is automatically protected, thereby preventing a service fail.

In the system operation mode of the ring operation mode, the optical signal transmitting/receiving unit 10 is not duplexed, and the direction of receiving a path signal demultiplexed from the optical signal is switched to one of the east and west, thereby preventing a service fail. In this way, the function of automatically changing the direction of receiving a path signal so as to maintain the continuity of a service by automatically detecting a network fail in the system of the ring operation mode is called as “auto path protection function”. That is, a transmission signal is transmitted to both sides of the system, and a receiving signal is received from the direction of the good state, thereby maintaining the continuity of the path signal.

FIG. 3B is a view illustrating a path provision and auto path protection structure in the ring operation mode according to the conventional art. As illustrated in FIG. 3B, the optical transmission system of the ring operation mode receives optical signals from both directions, the east and west, and monitors the state of optical signals and demultiplexed path signals, for thereby changing the direction of receiving signals so that no service fail occurs when the corresponding signals have a fail.

Therefore, the system provides services according to the path provided by extracting a path signal capable of providing a subscriber service from a transmitted optical signal by using the path provision function and auto path protection function. In particular, the system allows the services to be normally maintained by overcoming a fail that is likely to occur in the network or system.

However, in the conventional path control method for voice-oriented services, as illustrated in FIG. 2, starting is achieved in one system while finishing is achieved in another system. Thus, the conventional path provision method is appropriate for voice and data services because a one-to-one path is maintained between two systems, while it is not appropriated for the requirements of recent high-speed and very high-speed data services.

In addition, in the conventional path protection method, since only signals transmitted to a path of the one-to-one connection state can be protected, it is hard for the system to send a subscriber's service signal to the entire systems of the transmission network, and the utilization ratio of a transmission signal path is degraded.

### SUMMARY OF THE INVENTION

Accordingly, it is an object of the present invention to provide a method for controlling a signal path in an optical transmission system for efficiently providing high-speed/very high-speed data services for which demand is being increased recently.

It is another object of the present invention to provide a method for controlling a signal path in an optical transmission system capable of providing an auto path protection function appropriate for high-speed/very high-speed data in a ring network.

It is still another object of the present invention to provide a method for controlling a signal path in an optical transmission system capable of carrying out new subscriber services by adding only a software function without changing the hardware of a conventional optical transmission system.

It is yet still another object of the present invention to provide a method for controlling a signal path in an optical transmission system for efficiently providing a variety of services at a time by effectively utilizing a signal bandwidth of a transmission network.

To achieve the above objects, there is provided a method for controlling a signal path in an optical transmission system according to the present invention, in which the path is provided and controlled by dividing the same into a subscriber service path for providing voice-oriented services as in the conventional art and a new subscriber service path for providing new high-speed/very high-speed data services, said new subscriber service path including a through path, add-drop path, ring add-drop path, east-west add-drop & through path, and east-west add-drop & through path.

To achieve the above objects, there is provided a method for controlling a signal path in an optical transmission system according to the present invention, which includes: the path provision step of providing a subscriber service path by dividing the same into a conventional service path and a new service path; the step of detecting a fail by periodically checking the conventional service path and the new service path; and the step of carrying out a conventional auto path protection function if the conventional service path has a fail, or carrying out a new auto path protection function through a message communication channel included in the overhead of a STM-n signal if the new service path has a fail.

Additional advantages, objects and features of the invention will become more apparent from the description which follows.

### BRIEF DESCRIPTION OF THE DRAWINGS

The present invention will become better understood with reference to the accompanying drawings which are given only by way of illustration and thus are not limitative of the present invention, wherein:

FIG. 1 is a block diagram of a general optical transmission system;

FIG. 2 is a view illustrating an example of a connection in a linear add-drop multiplex network according to the signal path provision method of the conventional art;

FIGS. 3A and 3B are views illustrating a signal path provision state by system operation modes according to the conventional art;

FIGS. 4A and 4B are views illustrating a signal path provision state by system operation modes according to the present invention;

FIG. 5 is a view illustrating an example of a connection in a linear add-drop multiplex network according to the signal path provision method of the present invention;

FIG. 6 is a view illustrating a format configuration of a channel message transmitted between systems in order to carry out a path protection function in a method for providing a signal path in a transmission system according to the present invention;

FIG. 7 is a flow chart illustrating a signal path control method according to the present invention;

FIGS. 8A through 8F are views illustrating an auto path protection step in case of 2 fail occurrence according to the signal path provision method of the present invention in FIG. 7; and

FIG. 9 is a view illustrating a status signal and a path protection request signal transmitted and received between systems in FIGS. 8A through 8F.

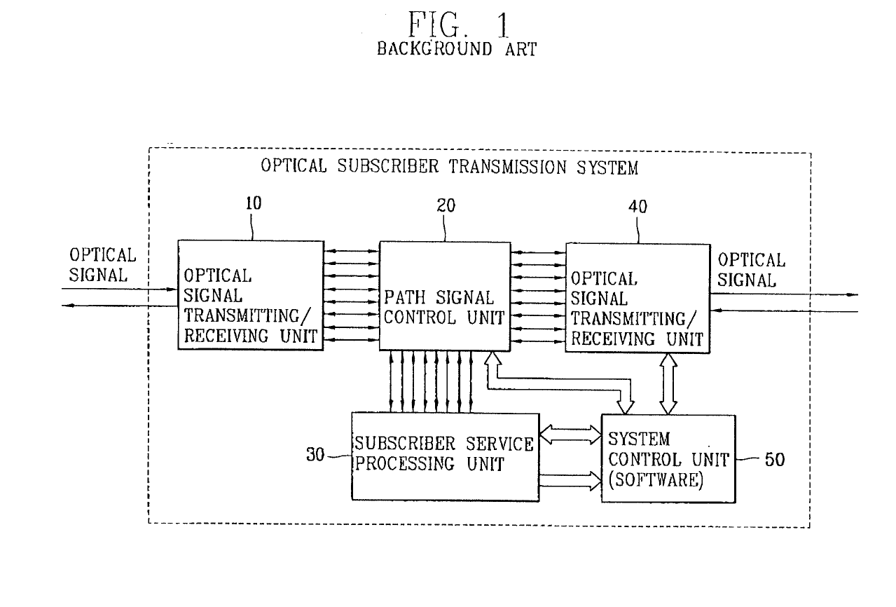

### DETAILED DESCRIPTION OF THE PREFERRED EMBODIMENTS

The preferred embodiment of the present invention will now be described with reference to the accompanying drawings.

The present invention efficiently provides new services such as high-speed/very high-speed data services to subscribers by supplementing a path provision function and an auto path protection function which have been provided for voice-oriented subscriber services in the conventional art. That is, the present invention provides a new service signal path different than that as in the conventional art, and provides a new path protection function by using the new service signal path.

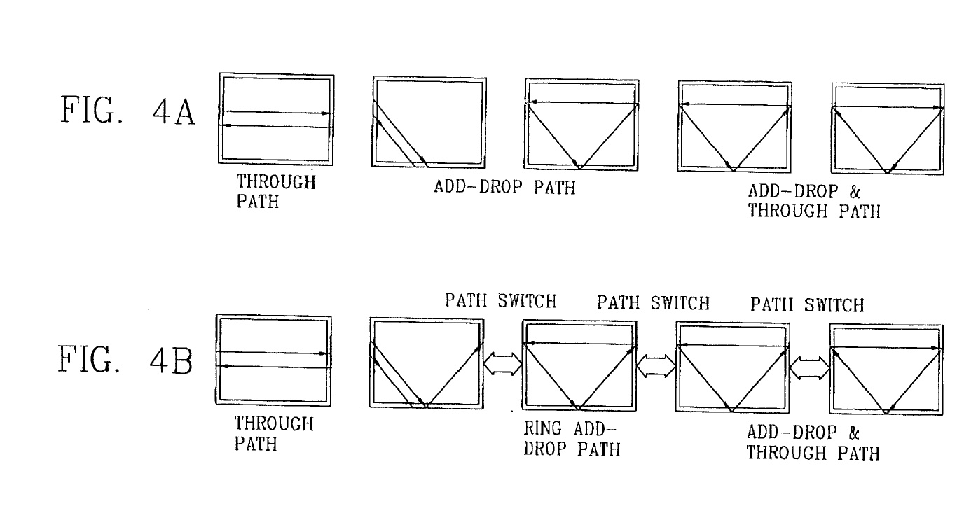

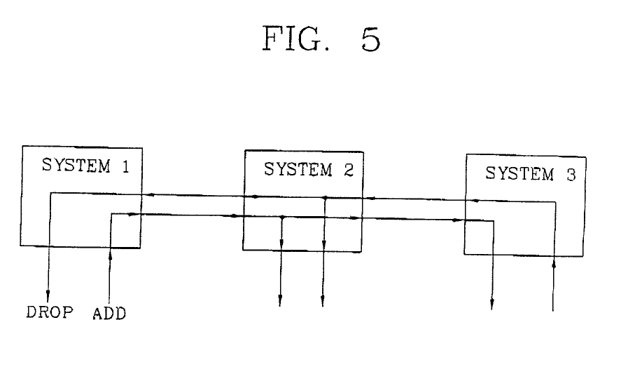

FIGS. 4A and 4B are views illustrating the construction of a service signal path of an optical transmission system according to the present invention.

As illustrated in FIGS. 4A and 4B, the present invention provides “path configuration control function” for providing a through path, add-drop path, ring add-drop path and add-drop & through path, and “auto path protection function” for automatically detecting a fail state in an undirectional protection self-healing ring network in the system of the ring operation mode for thereby assuring the continuity of services, according to a system operation mode and transmission network configuration.

The path configuration of the system in the terminal operation mode is identical to that as in the conventional art.

In the path configuration in the ADM operation mode, a bidirectional add-drop & through paths is included in addition to the conventional service path.

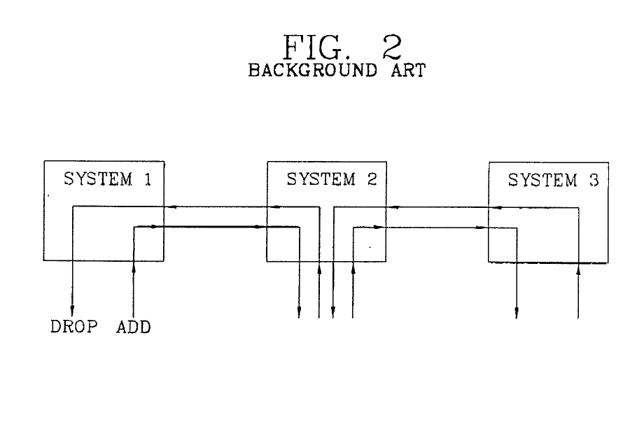

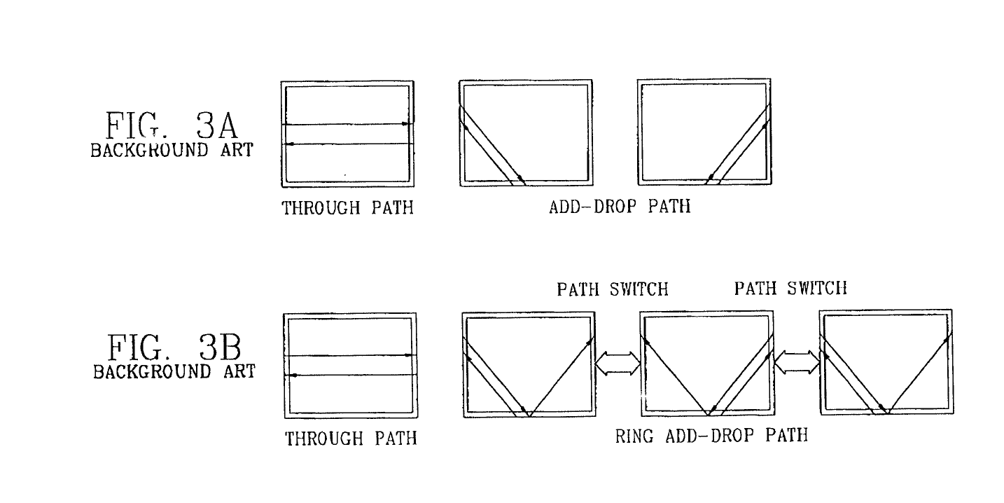

In other words, in the add-drop & through path, a path signal received from the east is dropped to a subscriber service processing unit 30, the path signal received from the subscriber service processing unit 30 is added to the west, and the path signal received from the west has a path passed through the east and a path of the opposite direction. At this time, the former path is called as an east-west add-drop & through path, and such a path configuration is called as “round”. Thus, the present invention can implements an one-to-n path configuration in which a path signal is added to system 1 and is dropped to system n, as well as an one-to-one path configuration as in the conventional art in the linear add-drop multiplex network as illustrated in FIG. 2.

In the system of the ring operation mode, bidirectional add-drop & through paths, i.e., an east-west add-drop & through path and a west-east add-drop & through path, are included in addition to the conventional path configuration. When an optical signal or path signal has a fail, the system carries out the same path protection as in the conventional art through the conventional path configuration according to the type of a service (conventional voice services or high-speed data services), or carries out path protection by means of the configuration of the bidirectional add-drop & through paths.

In order for the entire systems of a ring network to carry out such a path protection consistently, the systems periodically sends and receives a message containing the state of a local system, protection request of fail, ID (identification) of a local and remote system via a specific data channel. At this time, as the message communication channel, K1 and K2 bytes of a STM-n(Synchronous transmission Multiplex Signal Level n) overhead, i.e., a SDH(Synchronous Digital Hierarchy) signal, are used.

The K1 and K2 bytes are used for the protection of duplexed hardware (optical signal transmission/receiving unit) for transmitting and receiving an optical signal in the system of the terminal operation mode and ADM operation mode as in the conventional art, while they are not used in the undirectional protection self-healing ring network. Thus, the present invention uses the K1 and K2 bytes as the message communication channel in the undirectional protection self-healing ring network.

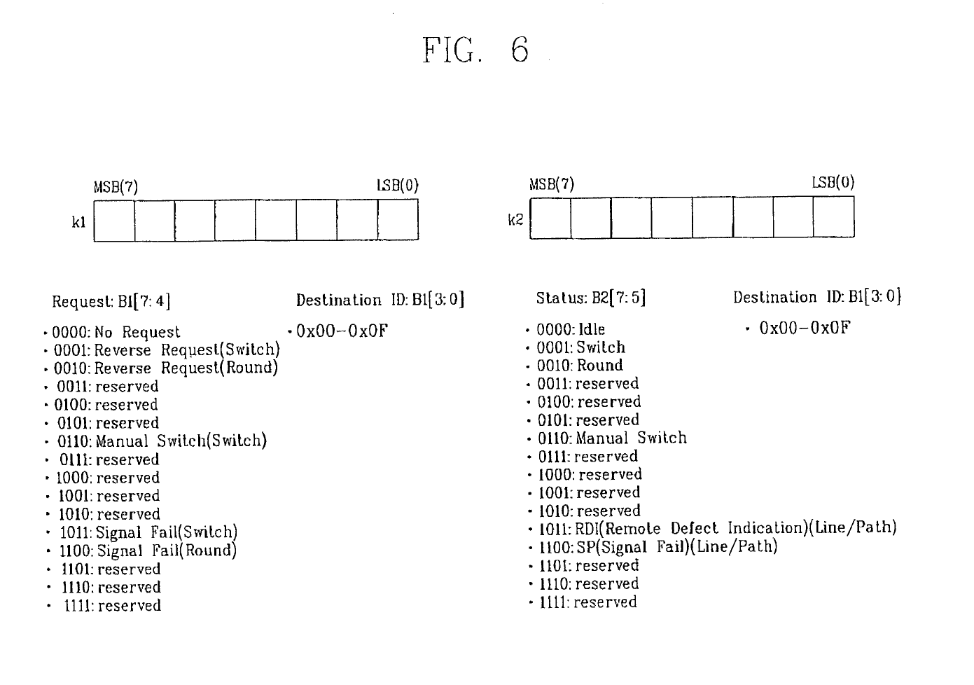

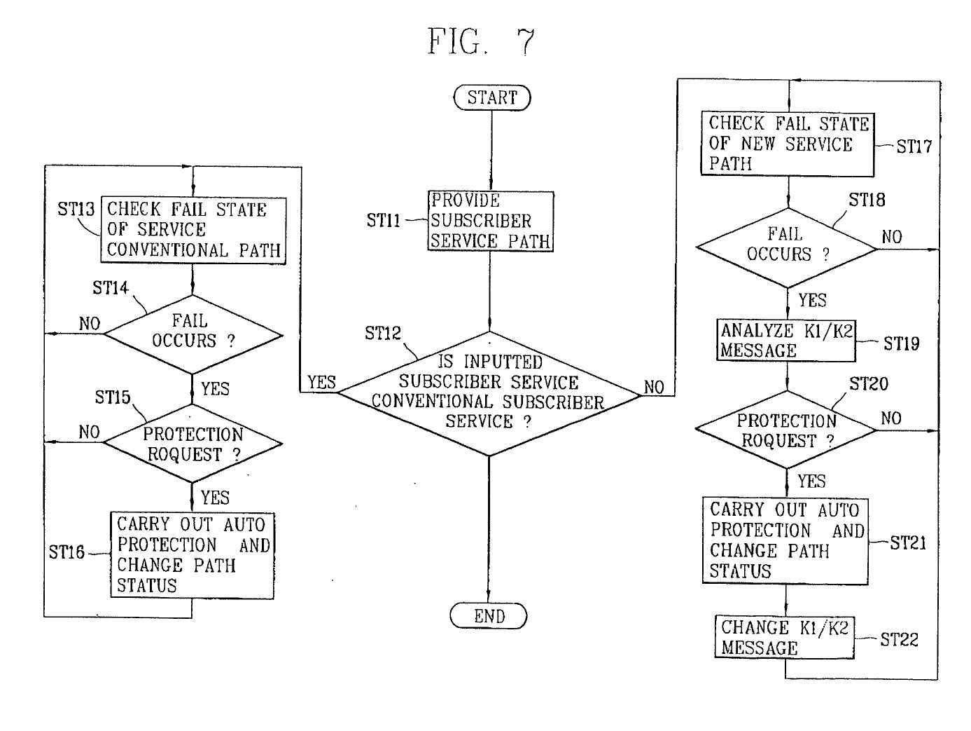

FIG. 6 is a view illustrating a message format transmitted and received between systems.

As illustrated in FIG. 6, the K1 byte (8 bits) contains a 4-bit “protection request” signal for use in protection, and a 4-bit “remote system Id(remote system or destination Id) for carrying out a protection request. The K2 byte (8 bits) contains a 4-bit “system status signal” for checking the status of a local system by a remote system, and a 4-bit “local system Id(local system or source Id).

The “protection request” signal includes a no request signal (NRS) representing that it is unnecessary to carry out protection, a switch signal for switching only the direction of a signal path, a round signal for assuring the continuity of a receiving signal, a reverse request switch(RRS) signal which is a response signal to the switch signal; a reverse request round signal(RRR) which is a response signal to the round signal, and a manual switch signal which is a manual path switch request.

And, the system status signal includes an idle signal representing a normal state, a rounded signal representing the state in which switch protection is carried out, a manual switched signal representing the state in which manual path protection is carried out, a remote defect indication (RDI) signal notifying that a remote system signal has a defect; a signal fail (SF) signal representing the direction in which a fail is detected and an auto protection message is forwarded, and an initialization signal representing that a system is in the initialization state.

And, in the same network, only 16 systems exists according to the Bellcore GR-253 specification, and the proper Id of a local system and remote system has a integer value from 0 to 15. Hence, all systems in the same network is configured such that they have a single signal path in which a path signal for a new service can be transmitted through all systems in the same network by the K1 and K2 bytes.

The system of the terminal operation mode and ADM operation mode does not provides the auto path protection function because it has a path in a fixed state, such as the through path, add-drop path, and add-drop & through path.

The systems of the ring operation mode have a ring add-drop path configuration at their initialization as in the conventional art in the undirectional protection self-healing ring network, If this state is called as a normal state, a state in which a fail occurs is called as a fail state.

When a problem occurs to a path signal currently in service due to a fail occurrence, the system that has detected the current fail state for the first time judges whether its signal path will be protected or not, carries out path protection, and then delivers a request of its state and protection to a remote system via the data channel (K1 and K2). Since then, the systems matches their path configuration with one another while transmitting/receiving K1 and K2 data. AT this time, the path must be configured in such a manner that a signal has to return to its starting point after passing through all systems in the network. Thus, by the above-mentioned path configuration, the present invention can usefully provides new services, and effectively use the bandwidth of a transmission signal.

First, the basic principle of the path protection is as follows.

1) The path protection function of a fail in optical signal can be carried out in the system of the ring operation mode.

2) All fails that can be recognized by a system are represented as a signal fail (SF), said SF including all fails that can affect path signal signals.

3) All systems before detecting a fail or carrying out protection is in the idle state, and all systems in the idle state deliver a no request signal (NRS).

4) The system having detected a SF delivers a state message of remote detect indication (RDI), and delivers a SF condition to the opposite direction, thereby making an adjacent system understand its state.

5) A message for protection is forwarded to one direction, and is not forwarded to both directions at a time.

6) The status of systems is transmitted to both directions, and each system judges its protection state and condition with reference to the status of an adjacent system.

7) The system having received a protection request signal must deliver a response signal notifying the system having transmitted the request signal that the protection request signal has been normally carried out.

8) The system having received the response signal stops the delivering of the protection request signal.

9) The system having detected does not delivers the protection request signal to the direction of detecting a SF.

10) the system having received a RDI signal carries out path protection in the opposite direction of the direction of receiving the RDI signal, and changes its status to the switched state.

11) The system having received a RDI signal does not deliver any protection request signal to the system in the opposite direction of the direction of receiving the RDI signal.

12) The system having detected a SF carries out protection of “ring add-drop path” in the opposite direction of the direction of receiving the SF, and changes the opposite direction of the direction of detecting the fail to “signal fail state (SF state), and changes the direction of detecting the fail to “remote defect state (RDI state)”.

13) the system having detected a SF delivers a protection request signal for carrying out protection of “ring add-drop & through path” in the opposite direction of the direction of receiving the SF.

14) If another protection request signal is inputted to the system in the switched state because protection has been already carried out, the corresponding system determines whether the protection is to be carried out or not by checking its status.

15) The system having received a RDI signal does not deliver a protection request signal to the next system.

Hereinafter, the path protection step of the present invention will now be described according to the basic principle of path protection with reference to FIG. 7

As illustrated in FIG. 7, each of the systems controls a signal path by dividing the same into a conventional signal path and a new signal path for subscriber services according to the present invention. At this time, the reason why the path for new services is controlled to be of a different path type is to adapt an additional function for new services later.

The conventional service signal path or new service signal path is provided according to the type of a subscriber service (conventional voice-oriented service or high-speed data service) inputted through the subscriber service processing unit 30 in ST11.

And, the type of the inputted subscriber service is checked in ST12, and if the requested subscriber service is a conventional subscriber service, each system detects a signal fail (SF) by periodically checking the status of the conventional service signal path in ST13. If a fail is detected in S14, each system judges whether auto path protection is to be carried out or not, and then requests path protection to other systems. If an auto protection request signal is inputted, the path protection of the “ring add-drop path” is carried out, and then the state of the path is changed and controlled in ST15 and ST16.

Meanwhile, if the requested subscriber service is a new subscriber service, each system detects a signal fail (SF) by periodically checking the state of the new service signal path in ST17. If a signal fail is detected in S18, each system judges whether auto protection is to be carried out or not by analyzing a K1/K2 message in ST19. As the result of the analysis, if a path protection request signal is inputted through the K1/K2 message, the corresponding system carries out auto path protection of the “ring add-drop path” and “ring add-drop & through path”, and thereafter changes and controls the state of the path in ST20 and ST21. And, the corresponding system transmits the status of a local system changed by means of the path protection and a path protection request signal to be carried out by a remote system to the remote system in ST22.

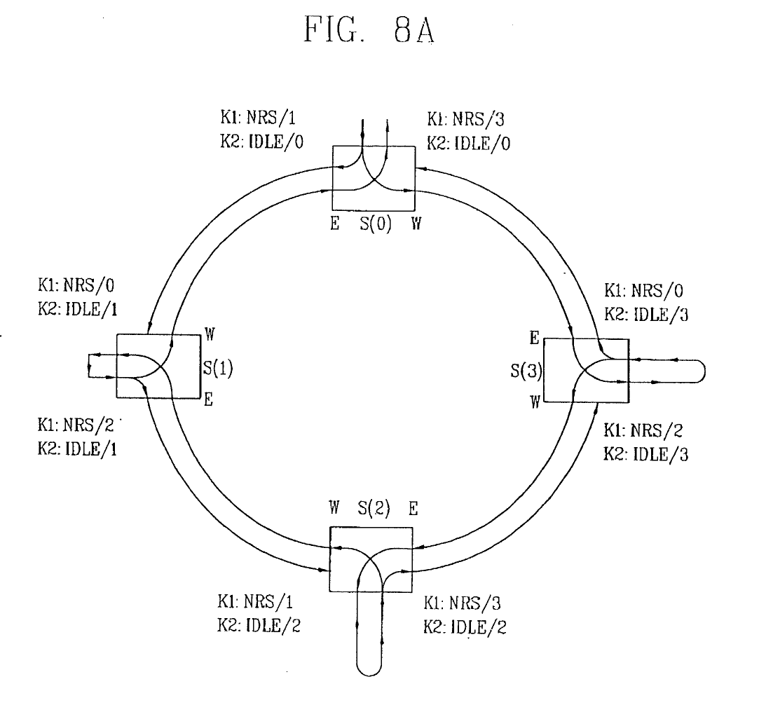

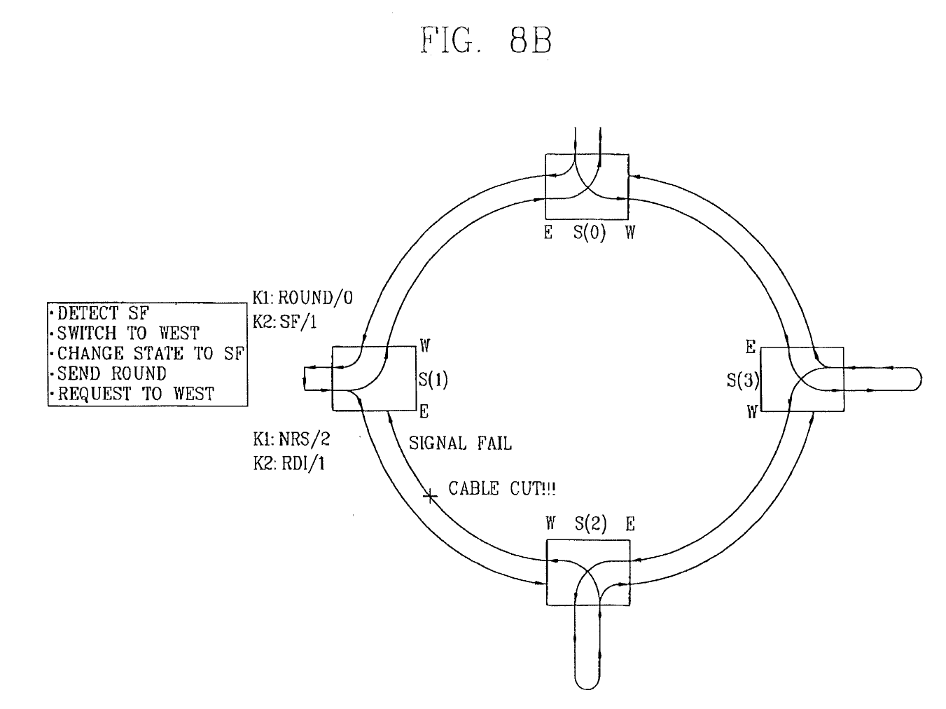

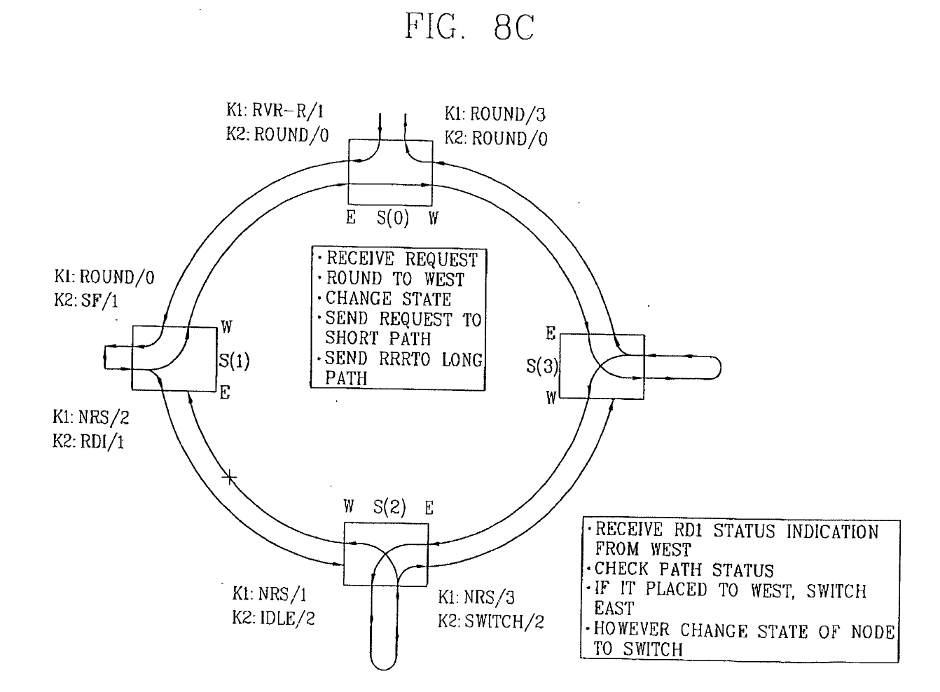

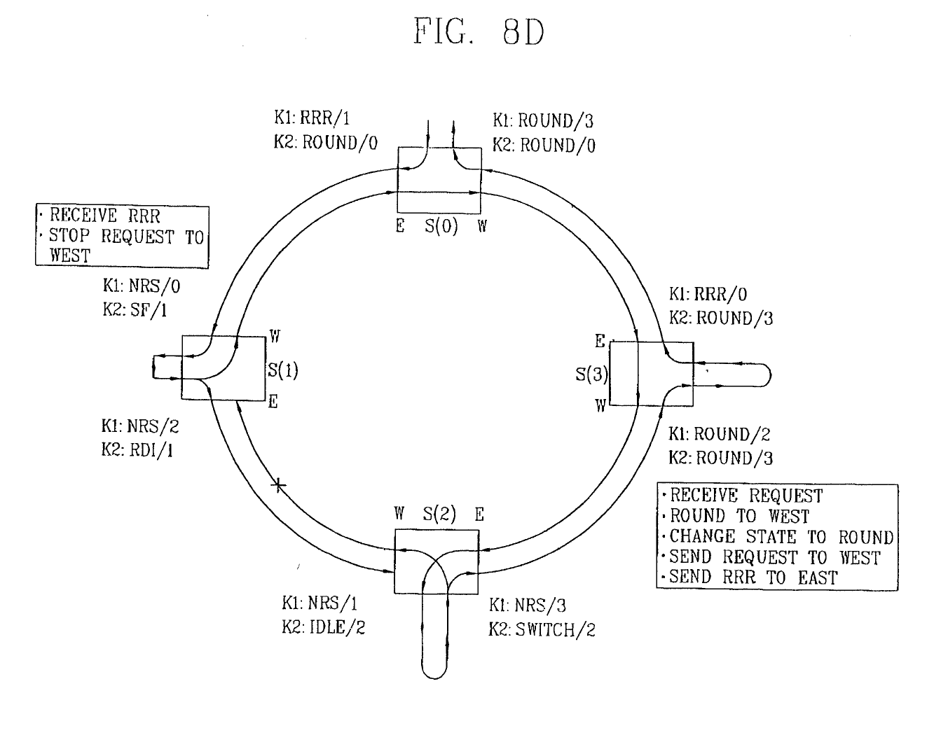

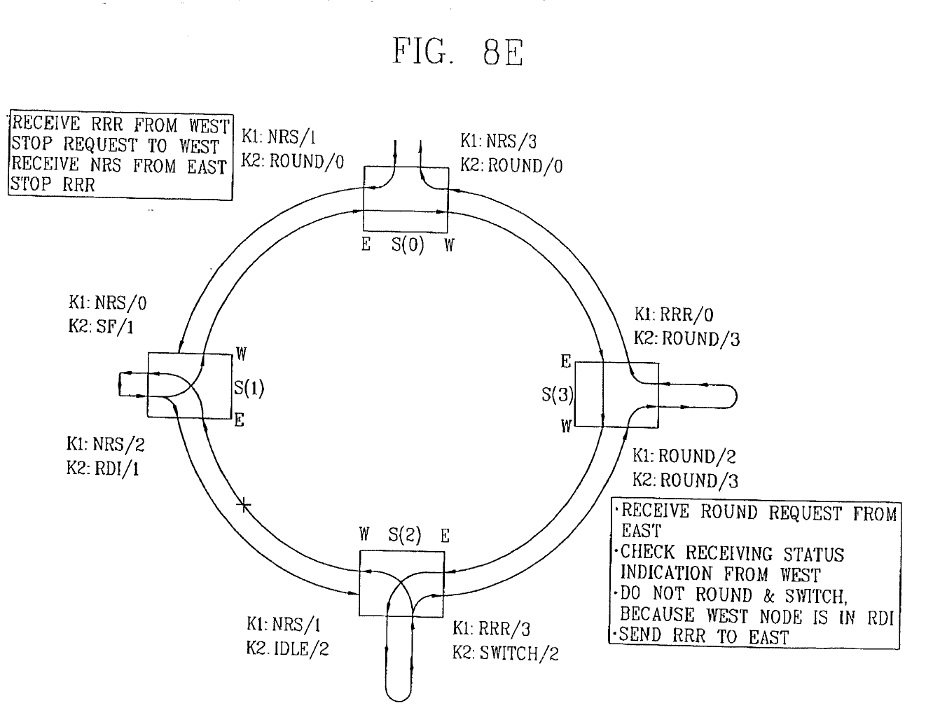

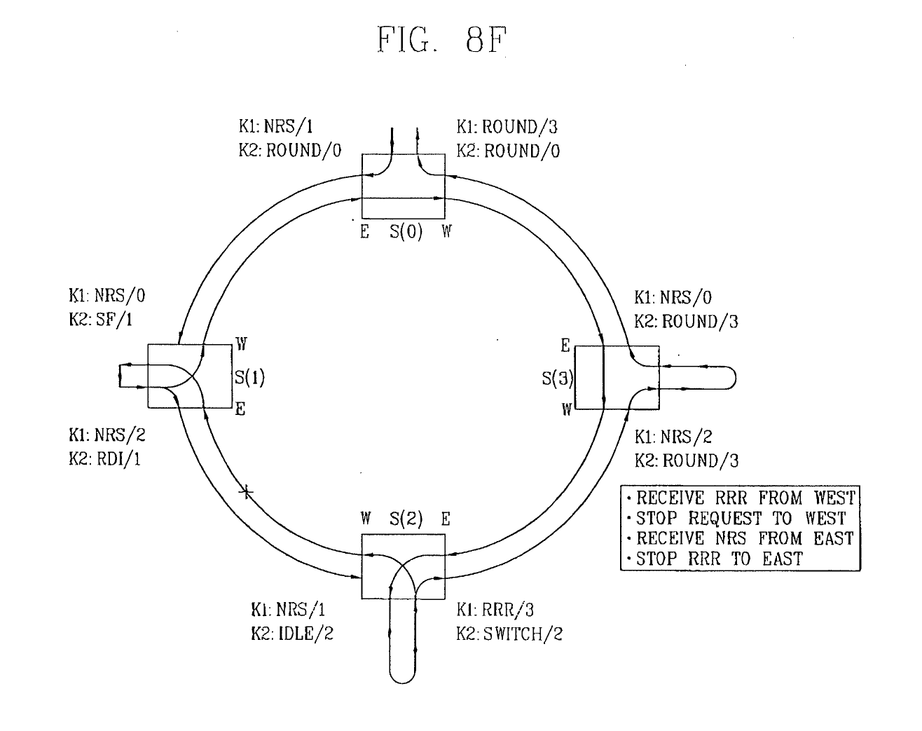

Hereinafter, the auto path protection step in the new service signal path will now be described in detail with reference to FIGS. 8A through 8F.

First, a ring network is comprised of four transmission network systems S0 through S3, and it is supposed that the current ring network is in the normal state as illustrated in FIG. 8A.

In the normal state, all systems S0 through S3 transmits and receives a no request signal (NRS) representing that auto path protection is unnecessary, and an idle signal representing that their status is currently in the idle state to/from one another by K1 and K2 bytes, as illustrated in FIG. 8A.

Afterwards, as illustrated in FIG. 8B, if a signal fail (SF) occurs because a cable is disconnected between systems S1 and S2, the system S1 detects the signal fail (SF) and then changes its status from the normal state to the fail state.

The system S1 carries out auto protection of the “add-drop path”, i.e., automatically changes the direction of receiving a path signal from the east to the west, and thereafter delivers its status and a protection request to the system S0 by the K1 and K2. In addition, the system S1 changes tie opposite direction of the direction of detecting a SF to the “signal fail state (SF state)”, and changes the direction of receiving the SF to the “remote detect indication state (RDI state)”.

In other words, the system S1 transmits a path protection request signal (ROUND/0) for changing the current ring add-drop path to the ring add-drop & through path (rounded state), and delivers a signal fail signal (SF/1) and a RDI signal (RDI/1) respectively to the systems S0 and S2, thereby making the adjacent systems S0 and S2 easily understand their status.

The system S9 carries out a round-type path protection according to a path protection request signal (ROUND/0) as illustrated in FIG. 8C. For example, a path signal received from the west is dropped to the subscriber service processing unit, a path signal received from the subscriber service processing unit is added to the east, and a path signal received from the east is passed through the west.

If the path protection is completed, the system 0 changes its status to the “rounded state”, and then delivers its status signal (ROUND/0) respectively to the systems S1 and S3. And, the system S0 delivers a path protection request signal (ROUND/3) for carrying out the same path protection as itself to the system S3, and delivers a reverse request round (RRR/1), i.e., a response to the round request, to the system S1.

The system S2 having received the RDI signal (RDI/1) from the system S1 carries out path protection in the opposite direction of the direction of receiving the RDI signal, and then changes its status to the “switched state”. In other words, if a node is disposed at the west, it is switched to the east. Since the current signal path is disposed at the east, the system S2 does not changes the status of the node. If the path protection is completed, the system S2 delivers a status signal (Switched/2) to the system S3, and does not deliver any protection request to the system S3.

Therefore, as illustrated in FIG. 8D, the system S1 stops the delivering of a protection request signal (ROUND/1) to the system S0 according to the RRR/1 signal, and the system S3 carries out a round-type path protection. If the protection is completed, the system S3 changes its status to the rounded state, and then delivers a status signal (ROUND/0) to the systems S0 and S2. And, the system S3 delivers a path protection request signal (ROUND/2) to the system S2, and then delivers a reverse request round (RRR/0), i.e., a response to the ROUND/0 signal, to the system SO.

As illustrated in FIG. 8E, the system S0 does not delivers a protection request message to the system S3 according to the RRR/O signal, and the system S2 having received the path protection request signal (ROUND/2) checks its status and determines whether protection is to be carried out or not. In other words, the system S2 carries out path protection after checking the message transmitted from the system S1 and its status. Since the west side is in the RDI state, and the system S2 is in the switched state, no additional protection operation is carried out, and a reverse request round (RRR/3), i.e., a response to the ROUND/2 signal, is delivered to the system S3.

As illustrated in FIG. 8F, the system S3 does not deliver a ROUND/2 signal to the system S2 according to a RRR/3 signal of the system S2, and the system S2 finishes the delivering of the RRR/3 signal upon receipt of a NRS/2 signal from the system S3.

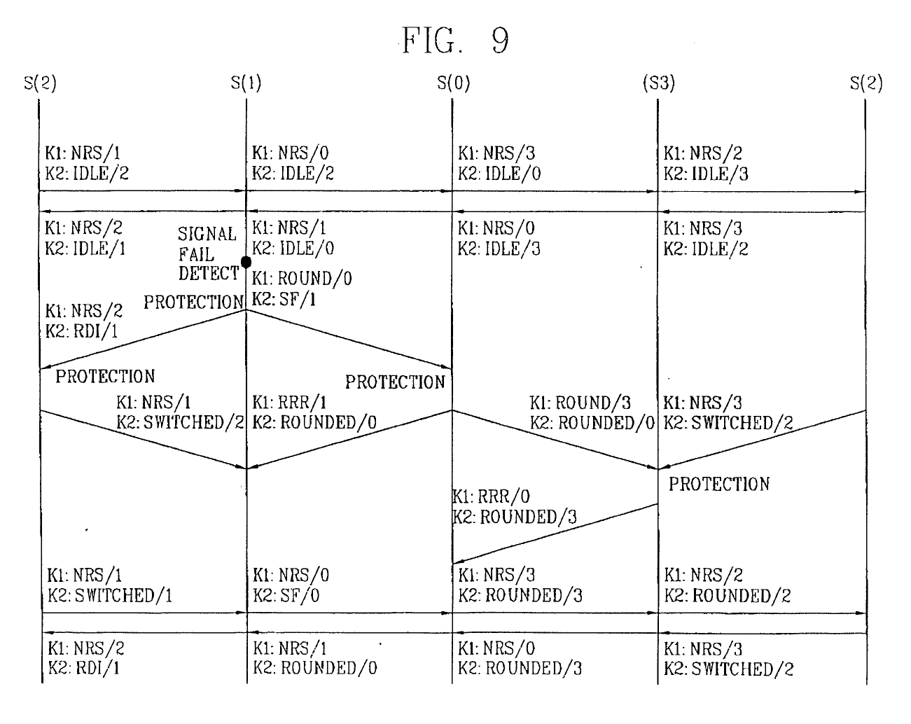

Therefore, as illustrated in FIG. 8F, if the path protection is all completed, the signal starting from the system S0 returns to the system 0 via the system S1, system S0, system S3, system S2, and system S3. Thus, the present invention to can provides new high-speed data services usefully. And, a status signal and a path protection request signal transmitted and received between the systems are illustrated in detail in FIG. 9.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

As described above, the present invention can provides a signal path provision and auto path protection method in an optical transmission system capable of providing an auto protection function and an one-to-one path provision function as in the conventional art, as well as high-speed and very high-speed new subscriber services.

In addition, the conventional path control method is appropriate for voice and low-speed data services, while the new path control method of the present invention is appropriate for a variety of high-speed data services. Thus, the optical transmission system having the path control method of the present invention can provides new high-speed data services as well as voice and low-speed data services as in the conventional art.

And, the present invention provides new subscriber services by adding a software function to the optical transmission system providing voice-oriented subscriber services as in the conventional art without changing hardware. Thus, conventional subscriber services and new services can be provided to one system at a time whereby service providers can continue to expand the range of new services without changing a network configuration.

In addition, the present invention can optimize the utilization ratio of a transmission signal by making the bandwidth of the transmission signal (voice signal, high-speed and very high-speed data signal) effectively used at an apparatus for processing a subscriber service.

What is claimed is:

1. A method for controlling a signal path in an optical transmission system, comprises:
the path provision step of providing a subscriber service path in the form of first and second service signal paths;
the step of detecting a fail by periodically checking the first and second service paths; and
the step of carrying out a conventional auto path protection function if the first service signal path has a fail, or carrying out a new auto path protection function through a message communication channel included in the overhead of a STM-n signal if the second service signal path has a fail.

2. The method according to claim 1, wherein the first service signal path is a path for providing voice and low-speed data services, and the second service signal path is a path for providing high-speed and very high-speed data services.

3. The method according to claim 1, wherein the first service signal path supports a through path and an add-drop path in the system of the terminal operation mode and ADM operation mode, respectively, and further supports a through path and a ring add-drop path in the ring operation mode.

4. The method according to claim 1 wherein the second service path further comprises an add-drop & through path in addition to the first subscriber service path.

5. The method according to claim 4, wherein the second service signal path supports a through path, an east-west add-drop & through path, and a west-east add-drop & through path in the system of the ADM operation mode.

6. The method according to claim 5, wherein the east-west add-drop & through path drops a path signal received from the east to the subscriber service processing unit, adds the path signal received from the subscriber service processing unit to the west, and passes the path signal received from the west through the east.

7. The method according to claim 5, wherein the west-east add-drop & through path drops a path signal received from the west to the subscriber service processing unit, adds the path signal received from the subscriber service processing unit to the east, and passes the path signal received from the east through the west.

8. The method according to claim 4, wherein the second service signal path supports a through path, ring add-drop path, east-west add-drop & through path, and west-east add-drop & through path in the system of the ring operation mode.

9. The method according to claim 1, wherein the message transmission channel uses K1 and k2 bytes of the overhead of a STM-n signal.

10. The method according to claim 9, wherein the K1 byte comprises;
a protection request signal; and
an Id of a remote system for carrying out a protection request.

11. The method according to claim 10, wherein the protection request signal comprises:
a no request signal representing that it is unnecessary to carry out protection;
a switch signal for switching only the direction of a signal path;
a round signal for assuring the continuity of a receiving signal;
a reverse request switch signal which is a response signal to the switch signal,
a reverse request round signal which is a response signal to the round signal: and
a manual switch signal which is a manual path switch request.

12. The method according to claim 9, wherein the K2 byte comprises;
a system status signal for checking the status of a local system by a remote system; and
a local system Id.

13. The method according to claim 12, wherein the system status signal comprises:
an idle signal representing a normal state;
a rounded signal representing the state in which switch protection is carried out;
a manual switched signal representing the state in which manual path protection is carried out;
a remote defect indication (RDI) signal notifying that a remote system signal has a defect:
a signal fail (SF) signal representing the direction in which a fail is detected and an auto protection message is forwarded; and
an initialization signal representing that a system is in the initialization state.

14. The method according to claim 1, wherein the step of protecting the new path is carried out only in the system of the ring operation mode.

15. The method according to claim 1, wherein, in the step of protecting the new path, a message for protection is transmitted in a single direction, and the system status is transmitted in both directions.

16. The method according to claim 15, wherein the system having received the protection request signal delivers a response signal notifying the system having transmitted the request signal that the protection request signal has been normally carried out

17. The method according to claim 16, wherein the system having received the response signal stops the delivering of the protection request signal.

18. The method according to claim 1, wherein, in the step of protecting the new path, all systems before detecting a fail or carrying out protection are in the idle state, and all systems in the idle state delivers a no request signal (NRS).

19. The method according to claim 1, wherein, in the step of protecting the new path, all fails that can be recognized by a system are represented as a signal fail (SF), said SF including all fails that can affect path signal services.

20. The method according to claim 19, wherein the system having detected the SF delivers a status message of remote detect indication (RDI) in the direction of detecting the SF, and delivers a SF signal in the opposite direction, thus making an adjacent system understand its status.

21. The method according to claim 19, wherein the system having detected the SF delivers a protection request signal for carrying out protection of “ring add-drop & through path” in the opposite direction of the direction of detecting the SF.

22. The method according to claim 19, wherein the system having detected the SF carries out protection of “ring add-drop path” in the opposite direction of the direction of detecting the SF, and changes the opposite direction of the direction of detecting the fail to “signal fail state (SF state)”, and changes the direction of detecting the fail to “remote defect indication state (RDI state).

23. The method according to claim 19, wherein the system having detected the SF does not deliver a protection request signal in the direction of detecting the SF.

24. The method according to claim 24, wherein the system having received the RDI signal carries out path protection in the opposite direction of the direction of receiving the RDI signal, and changes its status to the switched state.

25. The method according to claim 24, wherein the system that has already carried out the protection to be in the switched state carries out protection by checking its status upon receipt of a different path protection request signal.

26. The method according to claim 20, wherein the system having received the RDI signal does not deliver any protection request signal to the system disposed in the opposite direction of the direction of receiving the RDI signal.

27. The method according to claim 20, wherein the system having received the RDI signal does not deliver a protection request signal to the next system
